(19) United States
(12) Patent Application Publication
(10) Pub. No.: US 2004/0163108 A1
(43) Pub. Date: Aug. 19, 2004

(54) Receiver apparatus

(76) Inventors: Toshihiro Takagi, Osaka (JP); Yoshihisa Nagamura, Osaka (JP); Takahiro Katayama, Osaka (JP)

Correspondence Address: Jonathan P. Osha, ROSENTHAL & OSHA L.L.P., Suite 2800, 1221 McKinney St., Houston, TX, 77010, US

(21) Appl. No.: 10/744,842

(22) Filed: Dec. 23, 2003

(30) Foreign Application Priority Data
Dec. 27, 2002 (JP) P2002-379348

(51) Int. Cl. H04N 7/173; H04N 5/445; G06F 3/00; H04N 7/16; G06F 13/00

(52) U.S. Cl. 725/38; 725/37; 725/120; 725/135; 725/131; 725/139; 725/151; 725/50; 725/27

(57) ABSTRACT

A receiver apparatus accepts the registration/registration cancellation of a channel, while outputting a video signal for a picture based on channel information stored in a memory provided for a controller. Therefore, a user can perform a registration/registration cancellation of a physical channel, while examining the correlation between a virtual channel and a physical channel. Therefore, the user can easily register an unregistered physical channel, and the usability can be improved.

### BACKGROUND OF THE INVENTION

1. Field of the Invention

The present invention relates to a receiver apparatus for receiving a digital broadcast program and for outputting a video signal and an audio signal for this program.

2. Description of the Related Art

Conventionally, a channel registration function for registering channels is provided for a receiver apparatus that receives digital broadcast programs. This channel registration function permits a user to smoothly select channels, and provides improved usability. Specifically, the function skips unregistered channels during a channel tuning process, and as a result, because channels that carry no broadcast programs and channels that carry undesired broadcast programs are not registered (are unregistered), such channels are not selected during the tuning process, and channel tuning can be smoothly performed. Digital broadcast receiver apparatuses for which the channel registration function is provided are disclosed in, for example, JP-A-2002-232801 and JP-A-2002-77749.

Further, for digital broadcasting, a virtual channel is assigned to a physical channel representing a frequency band. When the same broadcast station, or an affiliated broadcast station, uses the virtual channel to provide a plurality of physical channels for a program, a user can detect and identify how these physical channels are correlated. When, for example, the same virtual channel is allocated for a plurality of physical channels used by the same broadcast station, or the affiliated broadcast station, a user can determine how these physical channels are correlated. Based on the virtual channel instead of the physical channel, ordinary users can identify the broadcast station and the broadcast program.

In addition, since a plurality of digital broadcast programs are carried by one physical channel, sub-channels are provided, and each sub-channel carries a broadcast program.

A conventional receiver apparatus stores a registered channel in memory, and deletes channels for which registration is canceled. The receiver apparatus accepts the registration and the registration cancellation of a selected channel. On the other hand, since a channel to be registered cannot be selected by channel tuning, a physical channel must be entered directly. As is described above, since a user identifies a broadcast station by referring to a virtual channel, not a physical channel, a user must obtain a corresponding physical channel, and must expend the labor required to perform the channel registration process (the tuning of a channel that is to be registered).

When a registered channel has been canceled erroneously and the channel need to be again registered, a corresponding physical channel must be obtained, and thus, labor is required to re-register the channel.

As is described above, for a conventional receiver apparatus, labor is required for channel registration, and the usability is poor.

### SUMMARY OF THE INVENTION

An objective of the present invention is to provide a receiver apparatus that stores, for each physical channel, a virtual channel number and a sub-channel number over which a program is broadcast, and outputs information concerning the correlation between the physical channel and the virtual channel in order to accept the registration of each physical channel, so as to reduce the load for channel registration which is imposed on a user.

To achieve this objective, a receiver apparatus according to the present invention has the following configuration.

(1) A receiver apparatus comprising;

a reception unit for receiving digital broadcast signals of physical channels including a selected sub-channel;

a program output unit for extracting, from the digital broadcast signals for the physical channels received by the reception unit, a broadcast signal for a program of a selected sub-channel, and for outputting a video signal and an audio signal obtained by decoding the broadcast signal;

a channel information storage unit for storing, for each physical channel, channel information indicating a correlation of information as to whether a channel has been registered, a virtual channel number and a sub-channel number;

a channel information output unit for employing the channel information stored in the channel information storage unit to generate and output an audio signal indicating a correlation with the number of a physical channel, registered or unregistered information, a virtual channel number and a sub-channel; and

a registration acceptance unit for accepting, for each physical channel, a registration or a registration cancellation while the channel information output unit outputs the video signal.

With this configuration, regardless of whether the physical channel is registered or not, the channel information storage unit stores, for each physical channel, an assigned virtual channel number, a sub-channel number for which a program is broadcast, and channel information correlated with information as to whether the channel information is registered or unregistered. Further, the channel information output unit employs the channel information stored in the channel information storage unit to generate and output an audio signal indicating a correlation with the physical channel number, the virtual channel number, the sub-channel number for the broadcasting of the program, and the information indicating whether the channel has been registered or has not been registered. The registration acceptance unit then accepts, for each physical channel, the registration or registration cancellation while the channel information output unit outputs the video signal.

As is described above, regardless of whether a physical channel is registered or not, a video picture is displayed that indicates the correlation of the allocated virtual channel number, the sub-channel number for the broadcasting of the program and information indicating whether the channel has been registered or de-registered, and the registration or the registration cancellation of a channel is accepted. Therefore, by displaying a video picture, the user can identify the correlation between the physical channel and the virtual channel, and can instruct the registration or the registration cancellation of the physical channel. As a result, the usability can be improved.

(2) The channel information output unit generates and outputs a video signal by superimposing a video picture based on the channel information and a video picture for a program of the selected sub-channel; and wherein the registration acceptance unit accepts the registration or registration cancellation of a physical channel that includes the selected sub-channel.

With this configuration, while watching a picture for the program that is broadcast across a channel that is to be registered or for which the registration is to be canceled, a user can instruct or cancel the registration, so that the usability can be even more improved.

(3) The receiver apparatus further comprises:

a channel information acquisition unit for switching physical channels for digital broadcast signals received by the reception unit, and for obtaining, as channel information, the number of a virtual channel allocated to each of the received physical channels, and the number of a sub-channel for which a program is broadcast; and

an updating unit for employing the channel information obtained by the channel information acquisition unit to update the channel information stored in the channel information storage unit.

With this configuration, while switching the physical channels, the channel information acquisition unit obtains, for each physical channel, the virtual channel number and the sub-channel number for a program that is broadcast, and updates the contents of the channel information storage unit.

Thus, when the digital broadcasting is started, even a physical channel that has not been used can be easily registered.

(4) The reception unit has a function for receiving an analog broadcast signal; and wherein the channel information stored in the channel information storage unit includes information indicating the physical channel is for digital broadcast or for analog broadcast.

With this arrangement, an analog broadcast across a physical channel can also be received.

(5) The receiver apparatus further comprises:

a determination unit for, when a digital broadcast signal or an analog broadcast signal of the selected physical channel is not received, examining whether the reception of another broadcast signal has been enabled, and determining whether the selected physical channel is for a digital broadcast or for an analog broadcast.

With this arrangement, a user need not be aware of whether the selected physical channel is for a digital broadcast or an analog broadcast.

### BRIEF DESCRIPTION OF THE DRAWINGS

FIG. 1 is a block diagram showing the configuration of a receiver apparatus according to one embodiment of the present invention;

FIG. 2 is a diagram showing the channel information stored in a memory provided for a controller;

FIG. 3 is a flowchart showing the channel switching operation performed by the receiver apparatus;

FIG. 4 is a flowchart showing the channel registration/registration cancellation processing; and

FIG. 5 is a diagram showing a picture according to a video signal output by a main body of the receiver apparatus during a channel registration/registration cancellation operation.

### DETAILED DESCRIPTION OF THE PREFFERED EMBODIMENTS

A receiver apparatus according to a preferred embodiment of the present invention will now be described.

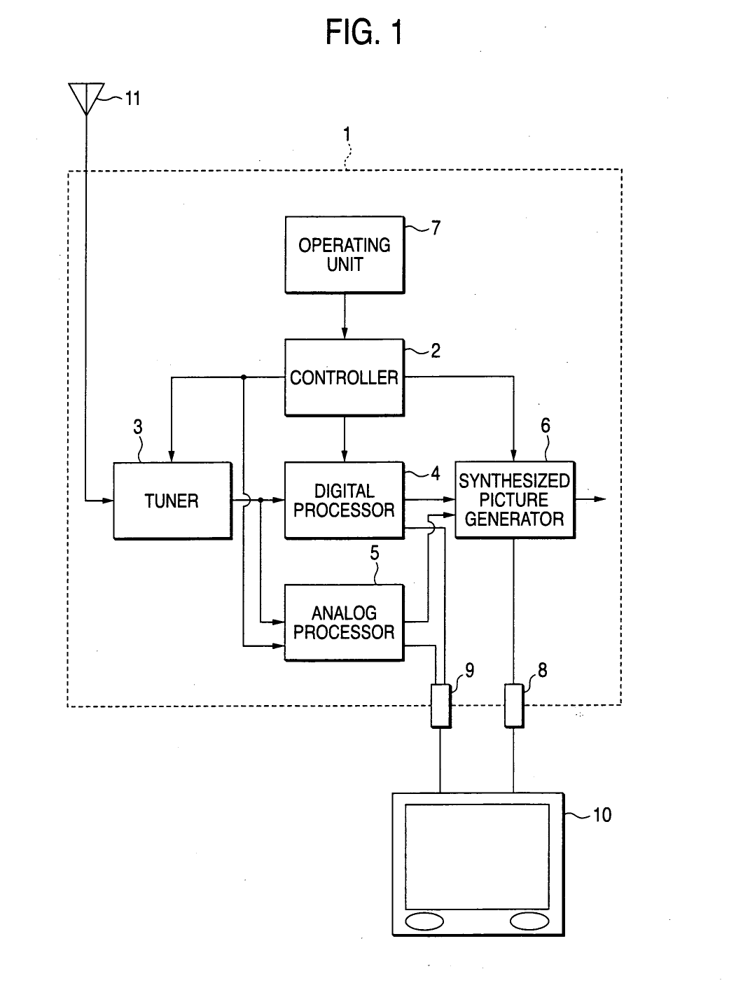

FIG. 1 is a block diagram showing the configuration of the receiver apparatus according to the embodiment of the invention. A receiver apparatus 1 in this embodiment comprises: a controller 2, a tuner 3, a digital processor 4, an analog processor 5, a synthesized picture generator 6 and an operating unit 7.

The controller 2 controls the overall operations, and has a memory (EEPROM) for storing channel information that will be described later. The tuner 3 extracts, from a broadcast signal received through an antenna 11, a broadcast signal for a selected physical channel. When the extracted broadcast signal is a digital broadcast signal, the tuner 3 transmits this signal to the digital processor 4. When the extracted broadcast signal is an analog broadcast signal, the tuner 3 transmits this analog signal to the analog processor 5.

The digital processor 4 extracts, from the received digital broadcast signal, data (data for a program) for a selected sub-channel, decodes this data, and outputs the obtained video signal and the audio signal. The analog processor 5 processes the received analog broadcast signal, and outputs the obtained video signal and audio signal. The synthesized picture generator 6 superimposes an OSD picture (e.g., a picture for channel information that will be described later) with the picture signal received from the digital processor 4 or the analog processor 5, and generates and outputs a video signal for the synthesized picture. The video signal generated by the synthesized picture generator 6 is externally transmitted through a video output terminal 8. The audio signal output by the digital processor 4 or the analog processor 5 is externally output through an audio output terminal 9.

The synthesized picture generator 6 may output, unchanged, a video signal received from the digital processor 4 or the analog processor 5.

Keys for entering instructions for the main body are provided for the operating unit 7, and a remote control receiver is also provided for receiving a control command from a remote controller. A display unit (e.g., a television receiver) 10 in FIG. 1 is used to enter a video signal output by the video output terminal 8 and an audio signal output by the audio output terminal 9.

As is well known, for digital broadcasting, a virtual channel number is allocated for a physical channel corresponding to a frequency band, and sub-channels are provided for simultaneously broadcasting a plurality of programs. Whereas generally for analog broadcasting, a virtual channel is not allocated for a physical channel and sub-channels are not provided. In this embodiment, for convenience sake, for physical channels for analog broadcasting, the number of a physical channel is assigned as a virtual channel, and the number of a sub-channel for over which the program is being aired is set to “0”.

For the digital broadcasting, “0” is not employed as the number for a sub-channel.

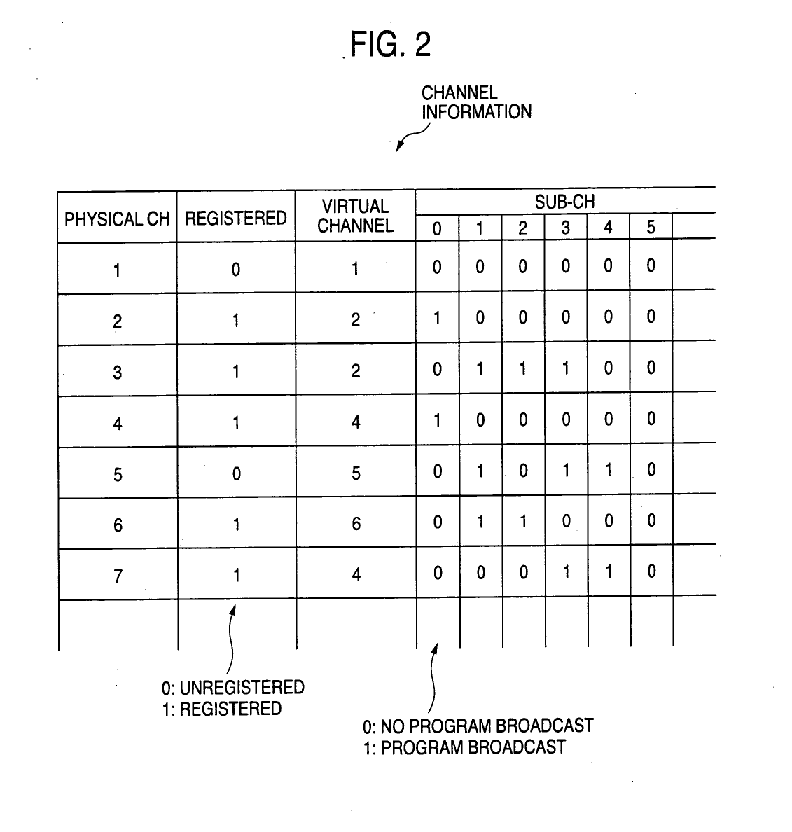

FIG. 2 is a diagram showing channel information stored in the memory provided for the controller 2. As is shown in FIG. 2, in this channel information, whether a physical channel is registered or not, a virtual channel number and the number of a sub-channel over which a program is to be broadcast are correlated with each physical channel. As is apparent from the above description, the channel information is also stored in the memory for a physical channel that has not yet been registered. Further, in the channel information, sub-channels “0” for which a program is broadcast are physical channels for analog broadcasting, sub-channels other than “0” for which a program is broadcast are physical channels for digital broadcasting, and channels having no sub-channels for which a program is broadcast are physical channels that are not employed for a television broadcast.

The operation of the receiver apparatus 1 for this embodiment will now be described.

First, the operation performed when a user is watching a program will be briefly described. A user selects a channel for which a desired program is broadcast.

When a physical channel for digital broadcast is selected, the tuner 3 of the receiver apparatus 1 extracts a digital broadcast signal for a selected physical channel, and transmits this signal to the digital processor 4. The digital processor 4 extracts data for a selected sub-channel from the received digital broadcast signal, decodes this data, and generates and output the obtained video signal and audio signal. The video signal is then transmitted to the synthesized picture generator 6, which thereafter outputs this signal from the video output terminal 8.

It should be noted that the synthesized picture generator 6 can also superimpose the picture of the received video signal with the picture indicating the current time, generate a video signal for the synthesized picture and output this video signal through the video output terminal 8.

The audio signal processed by the digital processor 4 is output through the audio signal output terminal 9.

When a physical channel for analog broadcast is selected, the tuner 3 of the receiver apparatus 1 extracts the analog broadcast signal for a physical channel selected by the tuner 3, and transmits this signal to the analog processor 5. The analog processor 5 processes the received analog broadcast signal, and generates a video signal and an audio signal. The video signal is transmitted to the synthesized picture generator 6, which then outputs this signal from the video output terminal 8. The audio signal is output through the audio output terminal 9.

Similarly, as when the physical channel for the digital broadcast is selected, the synthesized picture generator 6 can superimpose a picture of the received video signal on a picture indicating the current time, generate a video signal for the synthesized picture, and output this signal through the video output terminal 8.

Therefore, regardless of whether a selected physical channel is for digital broadcast or for analog broadcast, the user can watch and listen to, using the display unit 10 connected to the video output terminal 8 and the audio output terminal 9, a program of the selected channel.

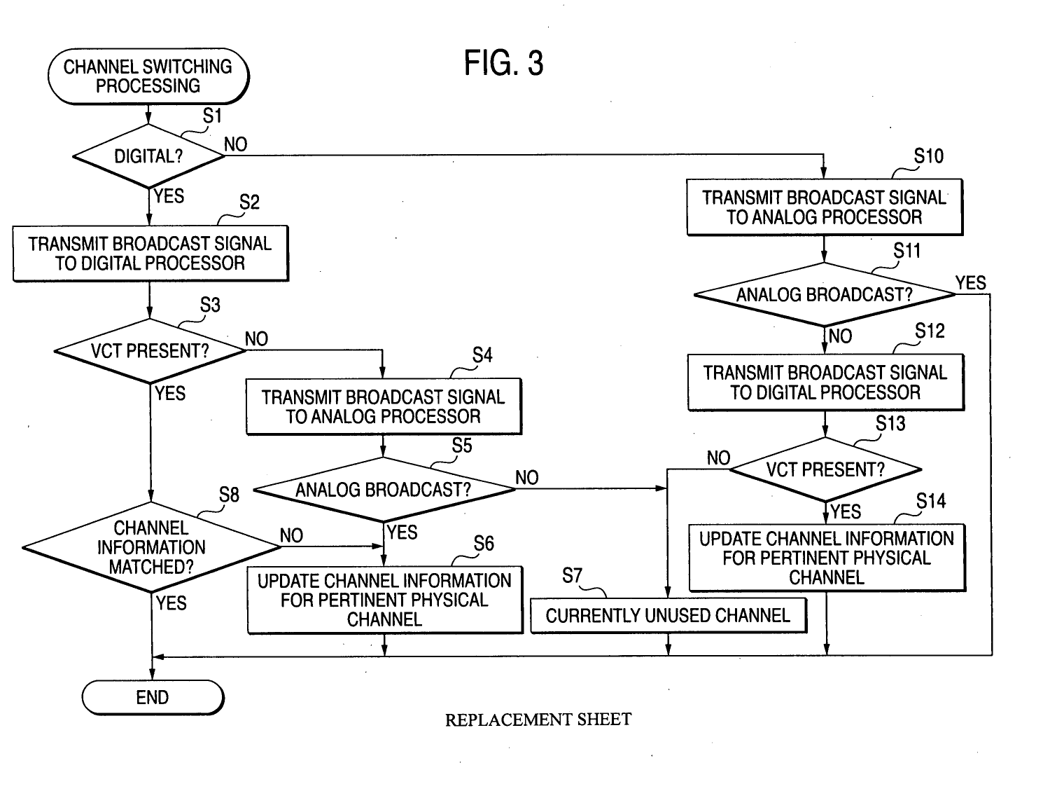

The channel switching processing will now be described. FIG. 3 is a flowchart showing the channel switching operation of the receiver apparatus 1. Upon receiving a channel switching instruction, the receiver apparatus 1 determines whether an instructed channel is for a digital broadcast or for an analog broadcast (S1). The decision at S1 is made based on the channel information stored in the memory in FIG. 2. Specifically, this decision is made depending on whether or not the sub-channel for which a program is broadcast and which is stored for the channel currently instructed for a change is “0”. When the number of the sub-channel is “0”, it is ascertained that the channel for the change is an analog broadcast channel. When the number of the sub-channel is other than “0”, it is ascertained that the channel for change is a channel for a digital broadcast.

When the receiver apparatus 1 determines that the channel for a change is a channel for a digital broadcast, the tuner 3 extracts a broadcast signal for a physical channel that currently is to be selected, and transmits this signal to the digital processor 4 (S2). Meanwhile, the digital processor 4 extracts a VCT from the received broadcast signal (S3). As is well known, the digital broadcast signal includes the VCT as information for a virtual channel number and the number of a sub-channel for which a program is currently being broadcast.

When the receiver apparatus 1 cannot extract the VCT at S3, the broadcast signal extracted by the tuner 3 is transmitted to the analog processor 5 (S4). This process is performed to confirm that the currently selected physical channel is not for a digital broadcast but is for an analog broadcast. When the analog processor 5 can extract a video signal and an audio signal from the received broadcast signal, the receiver apparatus 1 ascertains that the channel that has currently been selected is a physical channel for an analog broadcast, and updates the channel information for the pertinent physical channel stored in the memory (S5 and S6). When the analog processor 5 cannot extract the video signal and the audio signal from the received broadcast signal, the receiver apparatus 1 ascertains that the channel that is currently to be selected is an unused physical channel (S7). At this time, the channel information for the pertinent physical channel stored in the memory is not updated.

When the VCT can be extracted at S3, a check is performed to determine whether the channel information for the pertinent channel stored in the memory matches the channel information included in the VCT. When the two do not match, the channel information for the pertinent physical channel stored in the memory is updated (S8 and S6).

When the receiver apparatus 1 ascertains that the channel to be changed is for an analog broadcast, the tuner 3 extracts a broadcast signal for the physical channel that is currently to be selected, and transmits this signal to the analog processor 5. When the analog processor 5 cannot extract the video signal and the audio signal from the received broadcast signal, the broadcast signal extracted by the tuner 3 is transmitted to the digital processor (S11 and S12). This process is performed to confirm that the physical channel that has currently been selected is not for an analog broadcast but for a digital broadcast. The digital processor 4 then extracts the VCT from the received broadcast signal (S13). When the VCT cannot be extracted at S13, the receiver apparatus 1 ascertains that the channel that has currently been selected is an unused physical channel (S7). When the VCT is extracted at S13, the channel information for the pertinent physical channel stored in the memory is changed to the channel information included in the VCT (S14).

When this processing is terminated, the receiver apparatus 1 performs the operation to allow the user watch a program. Further, when it is ascertained that the currently selected channel is a physical channel that is not used for program broadcasting, a video signal for which only black is output by the video output signal 8, or the synthesized picture generator 6 may generate a video signal for a picture indicating the message “a program is currently not being broadcast” and may output this signal using the video output terminal 8.

As is described above, since whether the channel information stored in the memory is appropriate for a channel that has been has currently been selected is confirmed, and the channel information is updated if it is not appropriate, the user, for example, need not be aware that the physical channel that was once used for the analog broadcast is employed for the digital broadcast.

It should be noted that, during this processing, the channel information stored in the memory that indicates whether the physical channel has or has not been registered is not updated.

The channel switching operation in FIG. 3 may also be repetitively performed while the physical channels are switched in order. In this case, the channel information stored in the memory can be updated for all the physical channels.

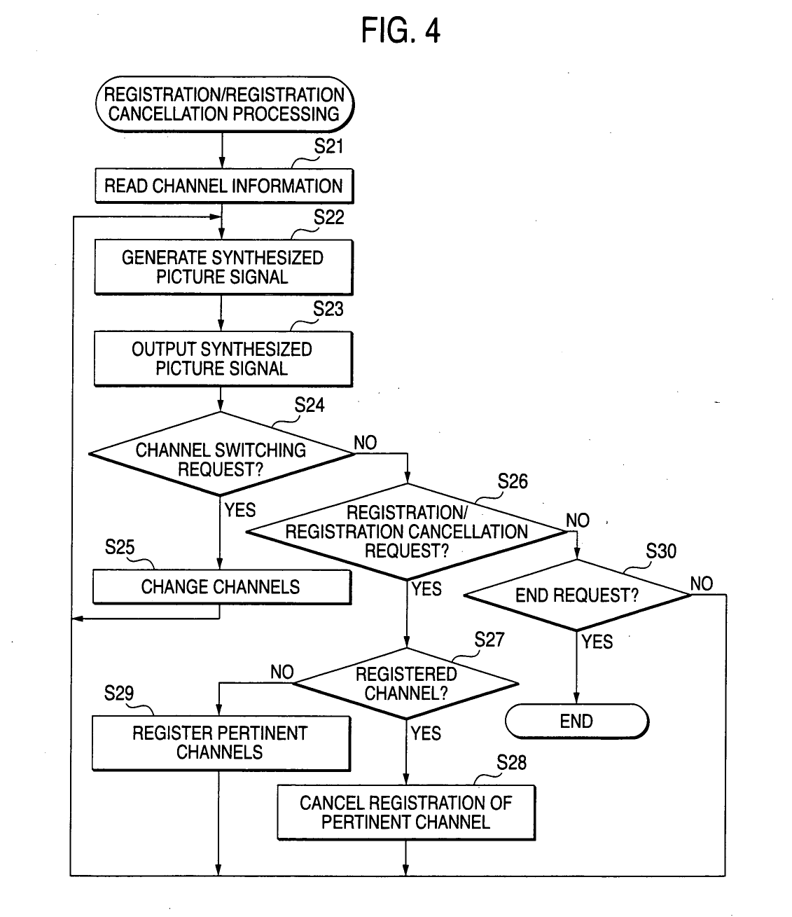

The channel registration/registration cancellation operation will now be described. FIG. 4 is a flowchart showing the channel registration/registration cancellation processing.

When a request to start the registration/registration cancellation processing is received, the receiver apparatus 1 starts this processing. This start request is entered by employing a predetermined manipulation using the operating unit 7 of the main body, or by employing a remote controller.

Upon receiving this start request, the receiver apparatus 1 reads the channel information stored in the memory of the controller 2 (S21). Then, the picture based on the channel information is superimposed on the picture of a program of the currently selected channel, and a synthesized picture signal is generated (S22) and is output through the video output terminal 8 (S23).

The currently selected channel may be either a channel for an analog broadcast or a channel for digital broadest.

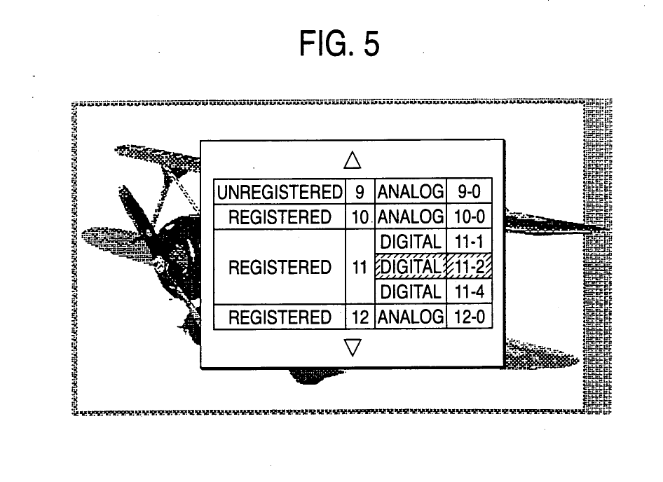

FIG. 5 is a diagram showing a display screen on the display unit 10 that receives the synthesized video signal generated at S23. As is shown in FIG. 5, a synthesized picture is displayed which is obtained by superimposing the channel information of a picture for a program of the currently selected channel. In the synthesized picture, a channel at a cursor position (a highlighted channel) shows a currently selected channel. In this synthesized picture, information as to whether it is registered or unregistered, information indicating whether it is a digital broadcast or an analog broadcast, and information indicating a virtual channel and a sub-channel are displayed for each physical channel.

When in this state a channel switching request is issued (S24), the receiver apparatus 1 changes the channel of a received program (S25), and program control returns to S22. The user need only perform a predetermined operation (an instruction to move a cursor upward or downward) by using the operating unit 7 or the remote controller, so that the channel can be changed.

In this processing, an unregistered channel can also be selected.

In the receiver apparatus 1, the video signal of a program of a channel selected in accordance with the channel switching request is transmitted to the synthesized picture generator 6. Then, the synthesized picture generator 6 generates a video signal, for a synthesized picture, whereby the cursor is moved to a selected channel.

Upon receiving a channel registration/registration cancellation request (S26) and when a currently selected channel is a registered channel, the receiver apparatus 1 cancels the registration (sets the channel to unregistered) (S27 and S28). While when the currently selected channel is an unregistered channel, the receiver apparatus 1 registers the channel (S27 and S29).

Since the receiver apparatus 1 accepts the registration of each physical channel, when a selected channel is a sub-channel for a broadcast, the receiver apparatus 1 either registers, or cancels the registration of, the physical channel that includes this sub-channel.

After the process at S28 or S29 has been completed, the apparatus 1 returns to S22 and repeats the above described processing.

Further, when a channel registration/registration cancellation end request is received (S30), the receiver apparatus 1 terminates the processing.

As is described above, the receiver apparatus 1 in this embodiment accepts the registration/registration cancellation of a channel, while outputting a video signal for a picture based on the channel information stored in the memory. Therefore, a user can perform the registration/registration cancellation for a physical channel, while examining the correlation of the virtual channel and the physical channel. Therefore, the user can easily register an unregistered physical channel, and the usability can be improved.

Further, while watching a program of a currently selected channel, i.e., a channel to be registered or to be canceled, a user can perform the registration/registration cancellation of a physical channel. Therefore, the user can avoid an erroneous cancellation of a registered physical channel, or the registration of an unnecessary channel. Therefore, the usability can be even more improved.

As is described above, according to the present invention, the registration/registration cancellation of a channel is accepted, while a video signal is output for a picture based on channel information stored in the main body. Therefore, a user can perform the registration/registration cancellation of a physical channel, while examining the correlation of a virtual channel and the physical channel. As a result, the user can easily register an unregistered physical channel, and the usability can be improved.

Furthermore, the user can perform a registration/registration cancellation for a physical channel while watching a picture produced by a program of a currently selected channel, i.e., a channel that is to be registered or canceled. Therefore, the user can avoid the erroneous cancellation of a registered physical channel, or the registration of a channel that is not required. Thus, the usability can be even more improved.

When a physical channel that was used for an analog broadcast is employed for a digital broadcast, or when a physical channel that was used for a digital broadcast is employed for an analog broadcast, the channel information stored in the main body is automatically updated during the channel tuning. Thus, a user need not be aware of this usage change.

What is claimed is:

1. A receiver apparatus comprising:
a reception unit for receiving digital broadcast signals or analog broadcast signals of physical channels including a selected sub-channel;
a program output unit for extracting, from the digital broadcast signals or the analog broadcast signals for the physical channels received by the reception unit, a broadcast signal for a program of a selected sub-channel, and for outputting a video signal and an audio signal obtained by decoding the broadcast signal;
a channel information storage unit for storing, for each physical channel, channel information indicating a correlation of information as to whether a channel has been registered, a virtual channel number, a sub-channel number, and information as to whether a channel is for an analog broadcast or for a digital broadcast;
a channel information output unit for employing the channel information stored in the channel information storage unit to superimpose, with a picture of a program of the selected sub-channel, a picture indicating a correlation with the number of a physical channel, registered or unregistered information, a virtual channel number and a sub-channel, and for outputting the obtained video signal;
a registration acceptance unit for accepting, for the physical channels including the selected sub-channel, a registration or a registration cancellation while the channel information output unit outputs the video signal;
a channel information acquisition unit for switching the physical channels for the digital broadcast signals received by the reception unit, and for obtaining, as channel information, the number of a virtual channel allocated to each of the received physical channels, and the number of a sub-channel for which a program is broadcast;
an updating unit for employing the channel information obtained by the channel information acquisition unit to update the channel information stored in the channel information storage unit; and
a determination unit for, when a digital broadcast signal or an analog broadcast signal of the selected physical channel is not received, examining whether the reception of another broadcast signal has been enabled, and determining whether the selected physical channel is for a digital broadcast or for an analog broadcast.

2. A receiver apparatus comprising:
a reception unit for receiving digital broadcast signals of physical channels including a selected sub-channel;
a program output unit for extracting, from the digital broadcast signals for the physical channels received by the reception unit, a broadcast signal for a program of a selected sub-channel, and for outputting a video signal and an audio signal obtained by decoding the broadcast signal;
a channel information storage unit for storing, for each physical channel, channel information indicating a correlation of information as to whether a channel has been registered, a virtual channel number and a sub-channel number;
a channel information output unit for employing the channel information stored in the channel information storage unit to generate and output an audio signal indicating a correlation with the number of a physical channel, registered or unregistered information, a virtual channel number and a sub-channel; and
a registration acceptance unit for accepting, for each physical channel, a registration or a registration cancellation while the channel information output unit outputs the video signal.

3. The receiver apparatus according to claim 2, wherein the channel information output unit generates and outputs a video signal by superimposing a video picture based on the channel information and a video picture for a program of the selected sub-channel; and wherein the registration acceptance unit accepts the registration or registration cancellation of a physical channel that includes the selected sub-channel.

4 The receiver apparatus according to claim 2, further comprising:
a channel information acquisition unit for switching physical channels for digital broadcast signals received by the reception unit, and for obtaining, as channel information, the number of a virtual channel allocated to each of the received physical channels, and the number of a sub-channel for which a program is broadcast; and
an updating unit for employing the channel information obtained by the channel information acquisition unit to update the channel information stored in the channel information storage unit.

5. The receiver apparatus according to claim 2, wherein the reception unit has a function for receiving an analog broadcast signal; and wherein the channel information stored in the channel information storage unit includes information indicating the physical channel is for digital broadcast or for analog broadcast.

6. The receiver apparatus according to claim 5, further comprising a determination unit for, when a digital broadcast signal or an analog broadcast signal of the selected physical channel is not received, examining whether the reception of another broadcast signal has been enabled, and determining whether the selected physical channel is for a digital broadcast or for an analog broadcast.
